(19) United States
(12) Patent Application Publication
(10) Pub. No.: US 2011/0302970 A1
(43) Pub. Date: Dec. 15, 2011

(54) Key - Key holder Combination

(75) Inventor: Scott AMRON, Smithtown, NY (US)

(73) Assignee: Keybrid, Inc., Woodside, NY (US)

(21) Appl. No.: 12/816,028

(22) Filed: Jun. 15, 2010

(51) Int. Cl. E05B 19/00

(52) U.S. Cl. 70/456 R; 70/431

(57) ABSTRACT

A key-key holder combination includes a key shank and a key holder. The key shank includes a distal tip and a proximate end. The key holder is fixedly connected to the proximate end of the key shank. The key holder includes a key holding portion for retaining a plurality of other keys thereon. The other keys are releasable and reattachable to the key holder.

### BACKGROUND OF THE INVENTION

1. Field of the Invention

The present invention relates to a key holder combined with a key shank.

2. Description of the Related Art

Keys are ubiquitous and multiple keys are used by each person every day. Accordingly, key rings and other types of key holders are used to hold all the keys that are used by one person. The head or bow of the key typically includes a through hole used to hold the key on a key ring.

Some keys have been designed with a quick release feature, such as the keys disclosed in U.S. Pat. No. 1,852,950 (Amrhein) and U.S. Pat. No. 4,176,534 (Denney). However, none of these key designs incorporate a key holder with a key, so that the key itself can hold other keys.

### SUMMARY OF THE INVENTION

An object of the present invention is to provide a key combined with a key holder for holding other keys.

The object of the present invention is met by a combined key and key holder. According to one embodiment, a key holder is fixedly connected to a proximate end of a key shank, wherein the key holder includes a key holder portion configured to retain a plurality of other keys thereon, the other keys being individually nondestructively releasable and reattachable to the key holder portion. The key shank includes a key blank that is cuttable by a key cutter for the key hole of a lock so that the combined key and key holder is a usable key.

The key holder is a split ring key holder according to a specific embodiment of the invention. The split ring key holder includes a first ring and a second ring connected by an intermediate connecting portion. The proximate end of the key shank is connected to one of the first ring and the second ring at a position on the key holder approximately opposite the intermediate connecting portion. The proximate end of the key shank may, for example, be welded, soldered or brazed to the split ring key holder. Furthermore, the key shank and at least a portion of the key holder to which the proximate end of the key shank is connected are made of dissimilar materials.

To facilitate the connection of the key shank to the split ring key holder, an outer side of the cross-section of the first and second rings is rectilinear. In a specific embodiment, the cross-section of the first and second rings is rectangular.

According to another embodiment, the key holder and the key shank are made as one single piece.

The key shank may comprise an electronic circuit or be an electronic key.

Instead of being a split ring, the key holder may alternatively comprise a carabiner, a slip sleeve, snap hook, or fobless RFID.

According to another embodiment, a combined key fob device and key holder is provided, in which the key fob device is fixedly connected to the key holder such that the key fob device and key holder are fixed with respect to each other. In this embodiment, the key fob device is one of a Radio Frequency Identification (RFID) device, a Universal Serial Bus (USB) device, a remote control device, and an electronic key. To attach the key fob device to the key holder, a metal support is welded, brazed or soldered to the key holder and the key fob device is fixed to the metal support.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like references denote similar elements throughout the several views:

FIG. 1 is a plan view of an example of a conventional key;

FIG. 2 is a perspective view of a key ring;

FIG. 3 is a cross-sectional view of the key ring of FIG. 2 along line

FIG. 4 is a perspective view of an embodiment of the present invention;

FIG. 5 is a sectional view of the embodiment of FIG. 4 along line V-V;

FIG. 6 is a perspective view of the embodiment of FIG. 4 used as a clip;

FIG. 7 is a perspective view of another embodiment of the present invention;

FIG. 8 is a perspective view of another embodiment of the present invention;

FIG. 9 is a plan view of another embodiment of the present invention;

FIG. 10 is a plan view of another embodiment of the present invention;

FIG. 11 is a plan view of another embodiment of the present invention; and

FIG. 12 is a plan view of another embodiment of the present invention.

### DETAILED DESCRIPTION OF THE PRESENTLY PREFERRED EMBODIMENTS

As shown in FIG. 1, a conventional key includes a head or bow portion 10 allowing the key to be handled by a user. A shaft 20 of the key includes a blade 30, which is inserted into a lock to change the state of the lock (i.e., locked or unlocked states), and a neck portion 40 disposed between the blade 30 and the head 10. A shoulder 35 is typically arranged between the neck 40 and the blade 30 to limit the insertion depth of the key into the lock. In some cases the shoulder 35 may be incorporated into the head 10.

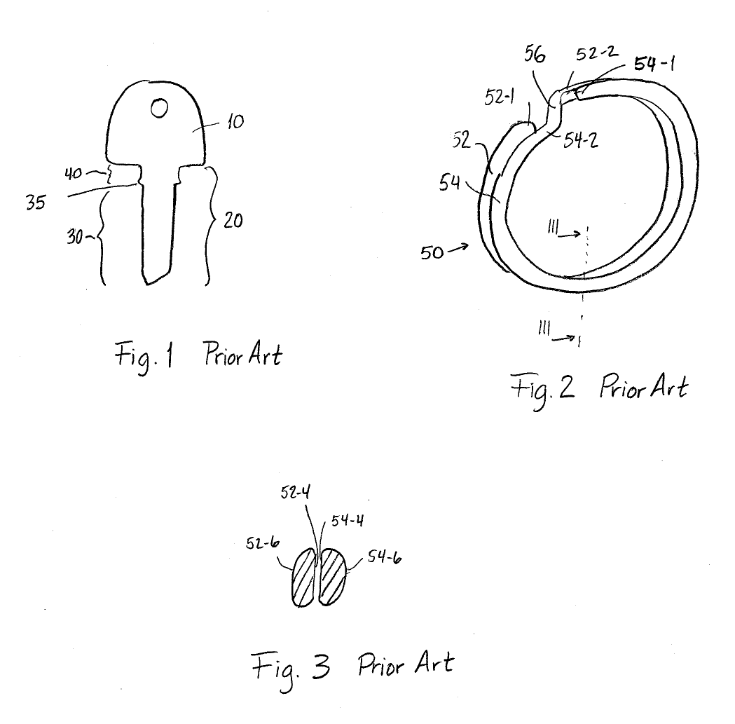

FIG. 2 shows a key holder 50 comprising a split ring having a first turn or first ring 52 and a second turn or second ring 54. The first turn 52 has a free end 52-1 and a connected end 52-2. The connected end 52-2 is connected to an intermediate connection piece 56. Likewise, the second turn 54 of the key holder 50 includes a free end 54-1 and a connected end 54-2. The intermediate connection piece 56 of the key holder is connected to the connected ends 52-2, 54-2 of the first and second rings 52, 54. In the embodiment of FIG. 2, the intermediate connection piece 56 is angled relative to each of the first and second turns such that each of the first and second turns extends circularly and not helically. As shown in the sectional view of the first and second rings 52, 54 in FIG. 3, the first and second turns 52, 54 each have a flat side 52-4, 54-4 facing the other of the first and second turns 52, 54 and a round outer side 52-6, 54-6.

Alternatively, the cross-section of the first and second rings 52, 54 could be circular. In this alternative, the intermediate connection piece 56 has the same cross section and is longitudinally aligned with the first and second rings 52, 54 such that the first and second rings 52, 54 could be arranged helically.

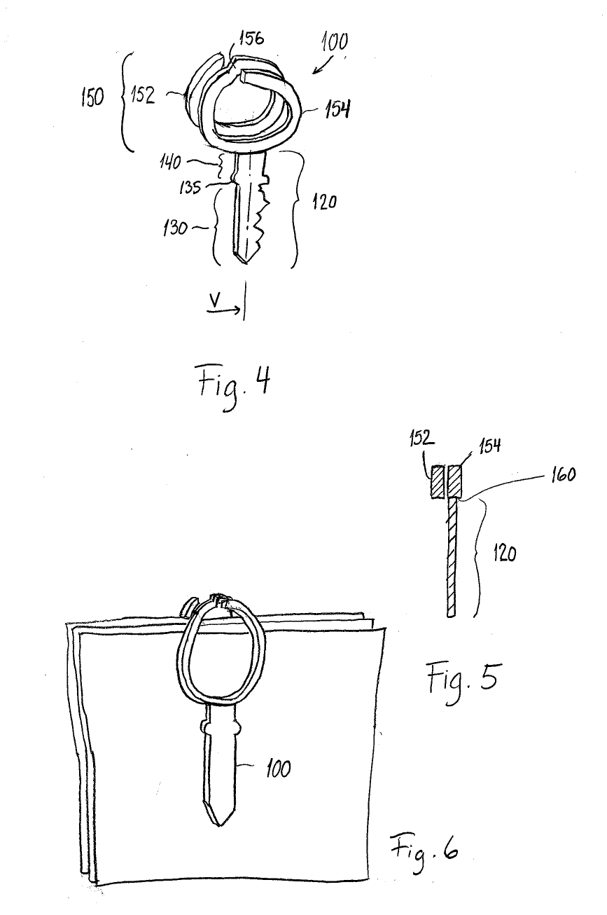

FIGS. 4-5 show the key-key holder combination 100 including a key holder 150 and a key shank 120 according to the present invention. The key holder 150 is similar to the key holder disclosed in FIGS. 2-3 and includes first and second rings 152, 154 connected by an intermediate connection piece 156. The first and second rings 152, 154 are shown separated in FIG. 4 for clarity, but would normally be held against each other as are the rings 52, 54 in FIG. 2. A neck 140 and blade 130 of the key shank 120 are connected to the second turn 154 at a location on the key holder 50 that is approximately opposite from the intermediate connection piece 156. As described in more detail below, the key blade 130 is cuttable by a key cutter for a key hole of a lock so that the key-key holder combination 100 is a usable key.

The key holder 150 and the key shank 120 are made from different materials because of the different functions of each piece. More specifically, the shank 120 is made of a softer material such as brass to facilitate cutting of the key by any conventional key cutter and the key holder 150 is made of a harder material such as hardened steel so that the key holder retains its shape. To connect these two dissimilar metals, the end of the shank 120 is soldered or brazed to the second turn 154 of the key holder 150. Furthermore, the end of the neck 120 is shaped to match the outer contour of the second turn 154 to which the end of the neck 120 is soldered or brazed (see FIG. 5). In one embodiment of the present invention, the solder or brazing material use is 70% silver and 30% brass. Using a temperature of approximately 200° C., the solder or brazing material melts and is distributed between shank 120 and the key holder 150. In the embodiment shown in FIGS. 4-5, the end of the shank 120 is the end of the neck 140. However, in some embodiments of the present invention, the shank 120 may include only a blade 130.

To optimize the strength of the connection between the shank 120 and the second turn 154 of the key holder 150, the contours of the end of the shank 120 and the outer side of the second turn 154 should be matched as closely as possible. To facilitate the matching of the contours, the cross-section of the first and second turns 152, 154 is rectangular (see FIG. 5). Although a rectangular cross-section is shown in FIG. 5, any cross-section having a rectilinear outer side 160 facing the end of the shank 120 may be used. As an alternative, the outer side facing the shank 120 may be curved.

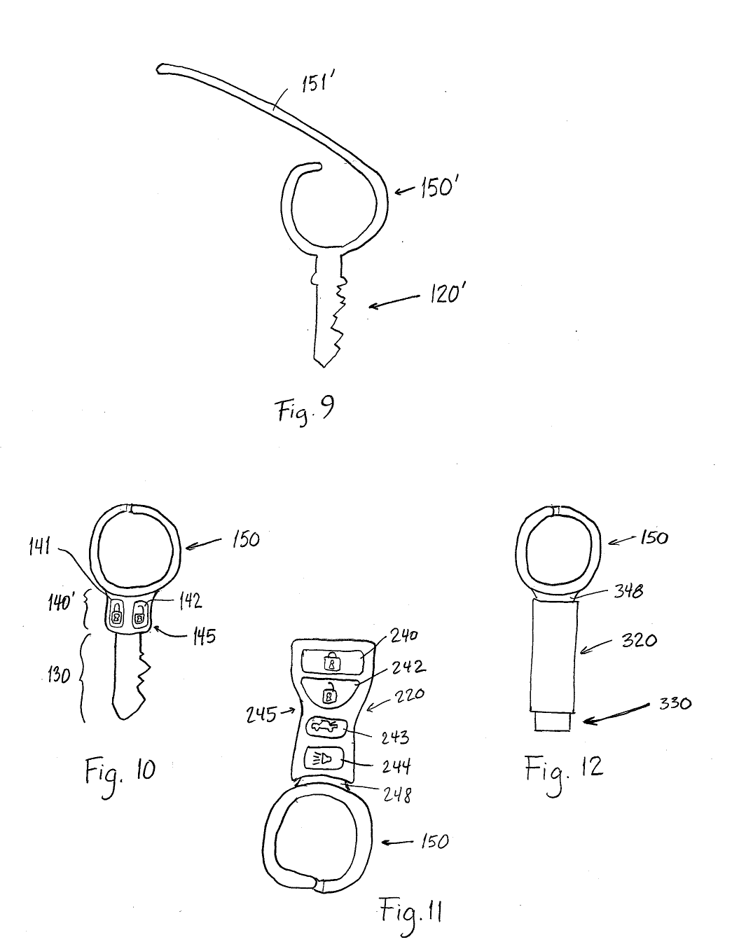

In an alternative embodiment shown in FIG. 9, the shank 120′ and key holder 150′ are made as a single piece of the same material. The shape shown in FIG. 9 could be punched or cast from a material that is a compromise between the hard material for retaining the shape of the key holder 150′ and the soft material that is soft enough to allow cutting of the key shank 120′. Such a material may comprise brass or nylon. After the shape shown in FIG. 9 is formed or cut, the extended portion 151′ is bent and/or worked to form the key holder such as the key holder shown in FIG. 4.

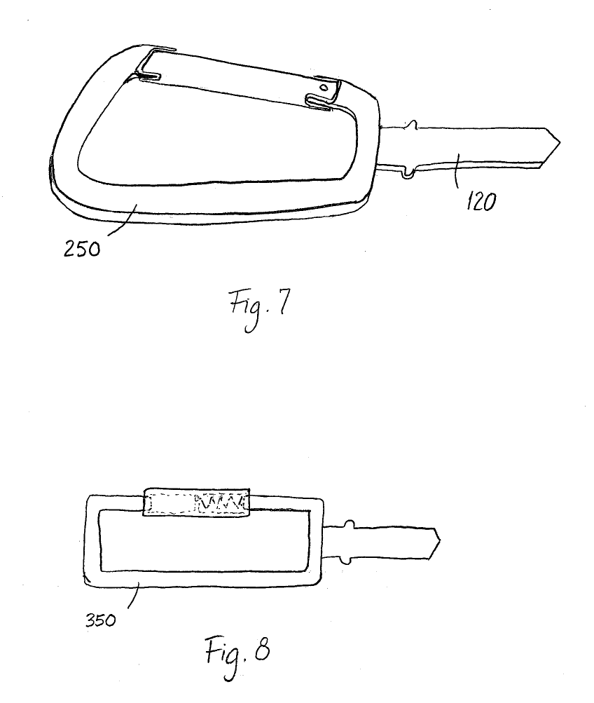

As shown in FIG. 6, the key-key holder combination 100 of FIGS. 4-5 also provides a clip, which can be used, e.g., for holding sheets of paper together, clipping the key-key holder to a clothing pocket, edges of a shirt, pant, or bag, or holding paper money as a money clip. For example, runners could clip the key to an article of clothing for their morning run. Applicant has noted that clipping an article of clothing in the key holder portion and pushing or pulling the material through the hole provides a secure attachment of the key-key holder combination to the clothing. The manipulations required for this use of the key-key holder combination 100 are possible because of the leverage afforded by the fixed attachment of the key shank 120, 120′ to the key holder 150, 150′.

Instead of a split ring key holder as shown in FIGS. 4-5, the key holder may alternatively comprise a snap-hook 250, such as a carabiner 250 shown in FIG. 7, or a slip sleeve key holder 350 shown in FIG. 8.

FIG. 10 shows an alternative embodiment in which the neck 140′ of the shank 120 includes an electronic circuit 145 having a lock button 141 and an unlock button 142 configured to activate remote lock and unlock functions, such as the lock and unlock button that are available on separate key fobs and/or on the head or bow portion of keys for most new vehicles. Although lock and unlock buttons 141, 142 are shown, buttons for any known and hereafter developed remote and other functions may alternatively or additionally be arranged on the circuit 145. In one alternative embodiment, the electronic circuit 145 includes an LED light actuatable by a push button, both of which are arranged on the neck 140′ of the shank 120. According to a further embodiment, the electronic circuit 145 is an electronic key allowing a keyless or pushbutton start of a motor vehicle. According to this embodiment, the key blade 130 may be configured to open a lock related to the motor vehicle, such as a glove box, trunk lid, storage lid or any other known or hereafter developed locks for motor vehicles.

FIG. 11 shows a further embodiment in which an electronic key 220 is connected to a key holder 150, such as the key holder of the FIG. 4 embodiment. The electronic key 220 is the type of electronic key allowing a keyless or pushbutton start of a motor vehicle. In FIG. 11, the electronic key includes an additional circuit 245 having buttons for performing further remote functions including a lock button 240, an unlock button 242, a hatch open button 243, and an alarm or panic button 244. Although four buttons are shown, the electronic circuit 245 may have buttons for activating any other known or hereafter developed functions additionally or alternatively arranged in the circuit 145. In this embodiment, the electronic key 220 has a metal support 248 connected to the key holder 150 by soldering or brazing similarly to the attachment of the shank 120 as described above. The electronic key may be mounted by injection molding onto the support, or may be connected by an known or hereafter developed fasteners including, but not limited to glue, adhesive, and fasteners such as screws, bolts, rivets. Alternatively, the electronic key 220 is connected directly to the key holder.

FIG. 12 shows yet another embodiment of the present invention in which a key fob device 330 is connected to the key holder 150. The device 330 may, for example, comprise at least one of a Universal Serial Bus (USB) device, a Radio Frequency Identification (RFID) device, or a bottle opener. The device 330 may additionally include an electronic key 320 such as the above described electronic key and may be include buttons for activating other functions as described above. In the embodiment of FIG. 12, a metal support 348 is connected to the key holder by soldering or brazing as described above and the device 330 is mounted on the metal support 348. The device may be mounted by injection molding onto the support, or may be connected by an known or hereafter developed fasteners including, but not limited to glue, adhesive, and fasteners such as screws, bolts, rivets. Alternatively, the device could be directly connected to the key holder.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A combined key and key holder, comprising a key having a key shank with a distal tip and a proximate end, and a key holder fixedly connected to the proximate end of the key shank such that the key and key holder are fixed with respect to each other, the key holder including a key holder portion configured to retain a plurality of other keys thereon, and the key holder being manipulable such that the other keys are individually nondestructively releasable and reattachable to the key holder portion.

2. The combined key and key holder of claim 1, wherein the key holder is a split ring key holder.

3. The combined key and key holder of claim 2, wherein the split ring key holder includes a first ring and a second ring connected by an intermediate connecting portion, the proximate end of the key shank being connected to one of the first ring and the second ring at a position on the key holder approximately opposite the intermediate connecting portion.

4. The combined key and key holder of claim 3, wherein the proximate end of the key shank is soldered or brazed to the split ring key holder using a solder or brazing material.

5. The combined key and key holder of claim 4, wherein the at least the proximate end of the key shank and a portion of the key holder to which the proximate end of the key shank is connected are made of dissimilar materials.

6. The combined key and key holder of claim 4, wherein the solder or brazing material comprises 70 wt.-% silver and 30 wt.-% brass.

7. The combined key and key holder of claim 3, wherein a cross-section of the first and second rings has an outer side that is rectilinear.

8. The combined key and key holder of claim 7, wherein the cross-section of the first and second rings is rectangular.

9. The combined key and key holder of claim 1, wherein the proximate end of the key shank is soldered or brazed to the key holder using a solder or brazing material.

10. The combined key and key holder of claim 9, wherein at least the proximate end of the key shank and a portion of the key holder to which the proximate end of the key shank is connected are made of dissimilar materials.

11. The combined key and key holder of claim 1, wherein the key holder is one of a snap ring and a spring sleeve key holder.

12. The combined key and key holder of claim 1, wherein the key shank further comprises a neck portion disposed between the key blade and the key holder, an electronic circuit being disposed on the neck portion of the key shank.

13. The combined key and key holder of claim 12, wherein the electronic circuit comprises lock and unlock buttons and is configured to wirelessly lock and unlock a car in response to actuation of the buttons.

14. The combined key and key holder of claim 12, wherein the electronic circuit comprises an electronic key.

15. A combined key fob device and key holder, the key fob device having a distal tip and a proximate end, and a key holder fixedly connected to the proximate end of the key fob device such that the key fob device and key holder are fixed with respect to each other, wherein the key holder includes a key holder portion configured to retain a plurality of other keys thereon, the key holder being manipulable such that the other keys are individually nondestructively releasable and reattachable to the key holder portion.

16. The combined key fob device and key holder of claim 15, wherein the key holder is a split ring key holder including a first ring and a second ring connected by an intermediate connecting portion, the proximate end of the key shank being connected to one of the first ring and the second ring at a position on the key holder approximately opposite the intermediate connecting portion

17. The combined key fob device and key holder of claim 15, wherein the key fob device comprises one of an Radio Frequency Identification (RFID) device, a Universal Serial Bus (USB) device, a remote control electronic circuit having pushbuttons, and an electronic key.

18. The combined key fob device and key holder of claim 15, wherein the key fob device comprises a remote control electronic device having a pushbutton actuatable for one of locking a car, unlocking a car, opening a hatch, and sounding an alarm.

19. The combined key fob device and key holder of claim 15, wherein the key fob device further comprises a key blade attached to said electronic device such that said electronic device is disposed between the key blade and said key holder.

20. The combined key fob device and key holder of claim 15, wherein the key fob device comprises an electronic key.

21. The combined key fob device and key holder of claim 15, wherein the key fob device includes a bottle opener.

22. The combined key fob device and key holder of claim 15, wherein a metal support is brazed or soldered to said key holder and said key fob device is fixed to said metal support.

23. The combined key fob device and key holder of claim 16, wherein a metal support is brazed or soldered to said key holder and said key fob device is fixed to said metal support.
